(19) United States
(12) Patent Application Publication
(10) Pub. No.: US 2019/0382522 A1
(43) Pub. Date: Dec. 19, 2019

(54) POLYCARBONATE DIOL, POLYURETHANE FORMED THEREFROM, AND METHOD FOR FORMING POLYCARBONATE DIOL

(71) Applicant: INDUSTRIAL TECHNOLOGY RESEARCH INSTITUTE, Hsinchu (TW)

(72) Inventors: Cheng-Po KUO, Taipei City (TW); Kuo-Ching WU, Hsinchu City (TW); Wen-Pin CHUANG, Hsinchu City (TW); Shu-Jiuan HUANG, Taipei City (TW); Hsi-Yen HSU, Hsinchu City (TW); Chiou-Hwang LEE, Hsinchu City (TW)

(73) Assignee: INDUSTRIAL TECHNOLOGY RESEARCH INSTITUTE, Hsinchu (TW)

(21) Appl. No.: 16/195,130

(22) Filed: Nov. 19, 2018

(30) Foreign Application Priority Data
Jun. 19, 2018 (TW) 107120958

(51) Int. Cl. C08G 18/44; C08G 18/48; C08G 18/40; C08G 18/76

(52) U.S. Cl. CPC C08G 18/44; C08G 18/7671; C08G 18/4018; C08G 18/4825

(57) ABSTRACT

A polycarbonate diol is provided. The polycarbonate diol includes repeating units represented by formula (A) and formula (B), and hydroxyl groups located at both ends of the polycarbonate diol. The molar ratio of formula (A) to formula (B) is in a range from 1:99 to 99:1.

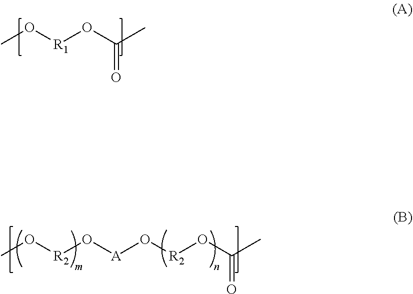

R₁ is a linear, branched or cyclic C₂₋₂₀ alkylene group. R₂ is a linear or branched C₂₋₁₀ alkylene group; m and n are independently and can be an integer from 0 to 10, and m+n≥1. A is a C₂₋₂₀ alicyclic hydrocarbon, aromatic ring or a structure represented by formula (C).

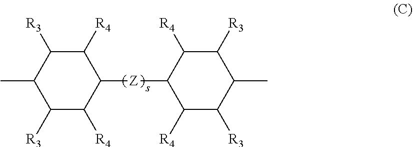

R₃ and R₄ are independently and can be a hydrogen atom or a C₁₋₆ alkyl group; S is 0 or 1; and Z is selected from

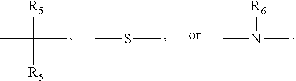

R₅ and R₆ are independently and can be a hydrogen atom or a C₁₋₁₂ hydrocarbon group.

### CROSS REFERENCE TO RELATED APPLICATIONS

This application claims priority of Taiwan Application No. 107120958, filed on Jun. 19, 2018, the entirety of which is incorporated by reference herein.

### TECHNICAL FIELD

The present disclosure relates to a polycarbonate diol and a polyurethane formed by the polycarbonate diol, and in particular it relates to a polycarbonate diol having repeating units of alkoxylated ring structure and a polyurethane formed by the polycarbonate diol having repeating units of alkoxylated ring structure.

### BACKGROUND

Polycarbonate diols (PCDL) have hydroxyl groups (—OH) at both ends of the structure, and the main chain contains the repeating units of aliphatic alkylene groups and carbonate groups. Polycarbonate diols are often used in the manufacturing of polyurethane (PU) or thermoplastic elastomers. Thermoplastic polyurethanes (TPU) possess the properties of softness and toughness and thus are widely applied in foam cushions, heat insulation panels, electronic potting gels, high-performance adhesives, surface coatings, packaging, surface sealants, synthetic fibers and so on.

As described above, polycarbonate diols can serve as a soft segment of polyurethane to improve the softness and toughness of polyurethane or thermoplastic elastomers. Compared with the conventional polyester polyols and polyether polyols, the thermoplastic polyurethane synthesized from polycarbonate diols has better hydrolysis resistance, thermal resistance, oxidation resistance, decomposition resistance, mechanical strength and so on.

1,6-hexanediols are generally used in the preparation of polycarbonate diols. However, polycarbonate diols that are formed by 1,6-hexanediols are in a solid state at room temperature and possess crystallinity, which causes difficulty in the operation of such polycarbonate diols. In addition, the softness and toughness of the polyurethane formed by such polycarbonate diols are poor. In view of the above problems, the existing method has attempted to prepare polycarbonate diols by copolymerizing the monomers having long carbon chain (e.g., 1,5-pentanediol and 1,6-hexanediol, or 1,4-butanediol and 1,6-hexanediol are used as monomers) or the diols having side chains (e.g., 3-methyl-1,5-pentanediol and 1,6-hexanediol are used). However, while the crystallinity is damaged using these methods, the mechanical strength of the polyurethane that is formed is also reduced.

Accordingly, it is desirable to develop polycarbonate diols that can effectively maintain both the mechanical strength and the ease of operability of the polyurethane that is formed.

### SUMMARY

In accordance with some embodiments of the present disclosure, a polycarbonate diol is provided. The polycarbonate diol comprises repeating units represented by formula (A) and formula (B), and hydroxyl groups located at both ends of the polycarbonate diol, wherein the molar ratio of formula (A) to formula (B) is in a range from 1:99 to 99:1,

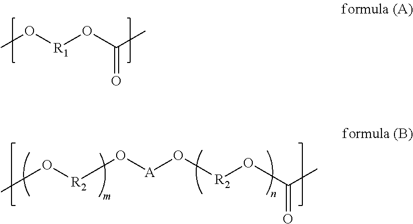

wherein, in formula (A), R₁ is a linear, branched or cyclic C₂₋₂₀ alkylene group; in formula (B), R₂ is a linear or branched C₂₋₁₀ alkylene group; m and n are independently and can be an integer from 0 to 10, and m+n≥1, and wherein A is a C₂₋₂₀ alicyclic hydrocarbon, aromatic ring or a structure represented by formula (C),

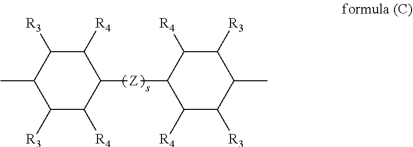

wherein, in formula (C), R₃ and R₄ are independently and can be a hydrogen atom or a C₁₋₆ alkyl group; S is 0 or 1; and Z is selected from

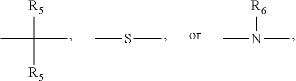

wherein, R₅ and R₆ are independently and can be a hydrogen atom or a C₁₋₁₂ hydrocarbon group.

In accordance with some embodiments of the present disclosure, a method for forming a polycarbonate diol is provided. The method includes performing a transesterification reaction with a first diol monomer, a second diol monomer and a dialkyl carbonate to form a polycarbonate prepolymer; and performing a condensation reaction with the polycarbonate prepolymer. The first diol monomer has a structure represented by HO—R₇—OH, and R₇ is a linear, branched or cyclic C₂₋₂₀ alkylene group. The second monomer is an alkoxylated diol.

In accordance with some embodiments of the present disclosure, a polyurethane is provided. The polyurethane is formed by the copolymerization of the above polycarbonate diol and a polyisocyanate.

### DETAILED DESCRIPTION

The polycarbonate diol and polyurethane of the present disclosure and the manufacturing method thereof are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the concept of the present disclosure may be embodied in various forms without being limited to those exemplary embodiments.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

The embodiments of the present disclosure provide a polycarbonate diol including the repeating units of alkoxylated ring structure, which can decrease the crystallinity of 1,4-butanediol or 1,6-hexanediol. The polycarbonate diol can exist in a liquid state at room temperature, and thus it is easily operated. In addition, the polyurethane formed by such polycarbonate diols can still maintain its mechanical strength. In the process for preparing the polyurethane, the polycarbonate diols also have good compatibility with the solvents used (e.g., the polyether polyols), and can be uniformly mixed at room temperature without demixing (forming different layers). Furthermore, compared with the polycarbonate diol having crystallinity, the polyurethane prepared from the polycarbonate diols provided in the embodiments of the present disclosure also has better compressive strength and is suitable for the use in foaming materials, thermoplastic elastomers, coatings, adhesives and so on.

In accordance with some embodiments, the polycarbonate diol is provided. The polycarbonate diol includes the repeating units represented by formula (A) and formula (B), and hydroxyl groups located at both ends of the polycarbonate diol.

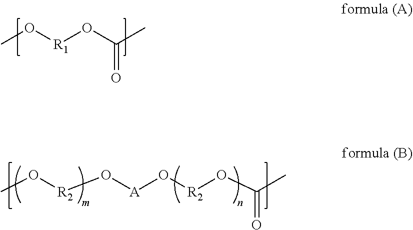

In formula (A), R₁ may be a linear, branched or cyclic C₂₋₂₀ alkylene group. In accordance with some embodiments, R₁ may be butylidene or hexylidene. For example, butylidene may include n-butylidene, t-butylidene, sec-butylidene or isobutylidene. Hexylidene may include n-hexylidene, t-hexylidene, sec-hexylidene or isohexylidene.

In formula (B), R₂ may be a linear or branched C₂₋₁₀ alkylene group, m and n are independently and can be an integer from 0 to 10. In addition, the sum of m and n may be greater than or equal to 1 (m+n≥1). In accordance with some embodiments, R₂ may be a C₂₋₃ alkylene group. For example, R₂ may be ethylidene or propylidene. Propylidene may include n-propylidene or isopropylidene. In accordance with some embodiments, the sum of m and n may be greater than or equal to 1 and less than or equal to 20 (1≤m+n≤20). In accordance with some embodiments, the sum of m and n may be greater than or equal to 1 and less than or equal to 10 (1≤m+n≤10). In other words, the sum of m and n (m+n) may be 1, 2, 3, 4, 5, 6, 7, 8, 9 or 10. In accordance with some other embodiments, the sum of m and n may be greater than or equal to 1 and less than or equal to 5 (1≤m+n≤5). In other words, the sum of m and n (m+n) may be 1, 2, 3, 4 or 5.

In addition, in formula (B), A may be a C₂₋₂₀ alicyclic hydrocarbon, aromatic ring or a structure represented by formula (C).

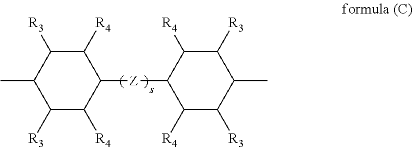

In formula (C), R₃ and R₄ are independently and can be a hydrogen atom or a C₁₋₆ alkyl group. For example, C₁₋₆ alkyl group may include methyl, ethyl, n-propyl, isopropyl, n-butyl, sec-butyl, tert-butyl, n-pentyl, sec-pentyl, isopentyl, tert-pentyl, 2-pentyl, cyclopentyl, n-hexyl, sec-hexyl, tert-hexyl, 2-hexyl, 3-hexyl or cyclohexyl. In addition, S may be 0 or 1. In accordance with some embodiments, formula (C) may be

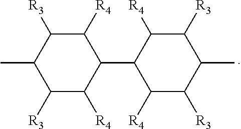

In accordance with some other embodiments, formula (C) may be

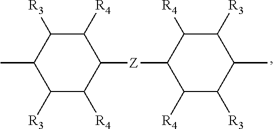

and Z may be selected from

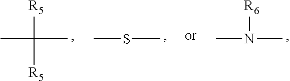

wherein, R₅ and R₆ are independently and can be a hydrogen atom or a C₁₋₁₂ hydrocarbon group. In accordance with some embodiments, R₅ may be a methyl group.

Specifically, in accordance with some embodiments, A of formula (B) may be

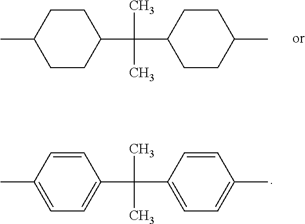

As described above, in formula (B), A may have a ring structure such as an alicyclic group or an aromatic ring. Therefore, formula (B) may be considered as the repeating unit that has alkoxylated ring structure. In particular, in accordance with some embodiments, the repeating unit that has alkoxylated ring structure can decrease the crystallinity of 1,4-butanediol or 1,6-hexanediol which serves as another repeating unit so that the formed polycarbonate diol can exist in the liquid state at room temperature.

In addition, in accordance with some embodiments, the molar ratio of formula (A) to formula (B) in the polycarbonate diol may be in a range from about 1:99 to about 99:1. In accordance with some embodiments, the molar ratio of the repeating units represented by formula (A) to the repeating units represented by formula (B) may be in a range from about 20:80 to about 80:20, or from about 30:70 to about 70:30, such as the molar ratio of 50:50.

In accordance with some embodiments, the number-average molecular weight (Mn) of the polycarbonate diol may be in a range from about 200 to about 10000. In accordance with some embodiments, the number-average molecular weight of the polycarbonate diol may be in a range from about 500 to about 5000.

In accordance with some embodiments, a polyurethane is provided. The polyurethane is formed by copolymerization of any of the polycarbonate diol as described in the above embodiments and a polyisocyanate. In accordance with some embodiments, the polyurethane may be a thermoplastic polyurethane.

In accordance with some embodiments, the polycarbonate diols may be prepared by the following steps. First, a transesterification reaction between diols and dialkyl carbonates is carried out so that the prepolymers of polycarbonates containing hydroxyl groups can be obtained by separating from the dialkyl carbonate. Next, the compounds still containing hydroxyl groups, the unreacted diol monomers and the unreacted dialkyl carbonates and so on are removed. The prepolymers of polycarbonates are subjected to a condensation reaction to obtain the polycarbonate diols.

In accordance with some embodiments, the above transesterification reaction is carried out using diol monomers and dialkyl carbonates. The diol monomers may have the structure represented by formula (D).

HO—R₇—OH formula(D)

In formula (D), R₇ may be a linear, branched or cyclic C₂₋₂₀ alkylene group. For example, the diol monomer having the structure of formula (D) may include ethane-1,2-diol, propane-1,2-diol, propane-1,3-diol, 2,2-dimethyl-1,3-propanediol, 1,4-butanediol, 2-isopropyl-1,4-butanediol, 1,5-pentanediol, 3-methyl-1,5-pentanediol, 2,4-dimethyl-1,5-pentanediol, 2,4-diethyl-1,5-pentanediol, 1,6-hexanediol, 2-ethyl-1,6-hexanediol, 1,7-heptanediol, 1,8-octanediol, 2-methyl-1,8-octanediol, 1,9-nonanediol, 1,10-decanediol, 1,3-cyclohexanediol, 1,4-cyclohexanediol, 1,4-cyclohexanedimethanol or 2-bis(4-hydroxycyclohexyl)-propane).

Moreover, one or more diol monomers represented by formula (D) can be used in the transesterification reaction. In accordance with some embodiments, 1,4-butanediol, 1,5-pentanediol, 1,6-hexanediol or a combination thereof are used in the transesterification reaction. In accordance with some embodiments, R₇ in formula (D) may be butylidene or hexylidene.

Moreover, in addition to the diol monomers as represented by formula (D), alkoxylated diol monomers are also used in the transesterification reaction so that the polycarbonate diols formed can have the repeating units as represented by formula (B).

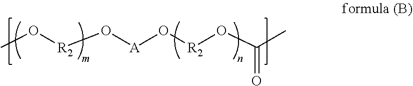

In formula (B), A may be a C₂₋₂₀ alicyclic hydrocarbon, aromatic ring or a structure represented by formula (C). R₂ may be a linear or branched C₂₋₁₀ alkylene group, and m and n are independently and can be an integer from 0 to 10. In addition, the sum of m and n may be greater than or equal to 1 (m+n≥1). In accordance with some embodiments, the sum of m and n may be greater than or equal to 1 and less than or equal to 10 (1≤m+n≤10), or may be greater than or equal to 1 and less than or equal to 5 (1≤m+n≤5). In addition, R₃ and R₄ are independently and can be a hydrogen atom or a C₁₋₆ alkyl group, S may be 0 or 1, and Z may be selected from

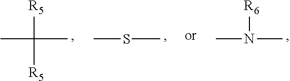

wherein, R₅ and R₆ each may be independently a hydrogen atom or a C₁₋₁₂ hydrocarbon group. Specifically, the repeating unit represented by formula (B) may be obtained by the reaction of the diol monomers including C₂₋₂₀ alicyclic hydrocarbon, aromatic ring or the structure represented by formula (C) with C₂₋₁₀ epoxide.

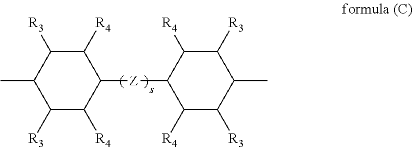

For example, in accordance with some embodiments, the alkylated diol monomers that are used to form the repeating unit represented by formula (B) may include 2-bis[4-(2-hydroxyethoxy)cyclohexyl]-propane, 2-bis[4-(2-hydroxyethoxy)phenyl]-propane, 2-[4-(2-hydroxyethoxy)cyclohexyl]-2-[4-(2-hydroxydiethoxy)cyclohexyl]-propane or 2-[4-(2-hydroxyethoxy)phenyl]-2-[4-(2-hydroxydiethoxy)phenyl]-propane. More specifically, the alkylated diol monomers that are used to form the repeating unit represented by formula (B) may have the structure represented by formula (E) or formula (F).

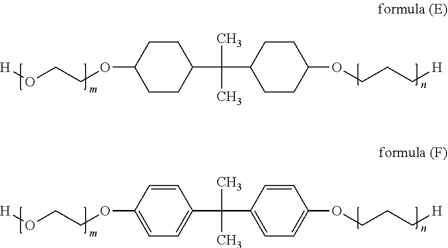

In accordance with some embodiments, the sum of m and n is 3 (m+n=3) in formula (E) or formula (F). In accordance with some embodiments, the sum of m and n is 2 (m+n=2) in formula (E) or formula (F). Moreover, for clarity, in the following embodiments, the structure shown in formula (E) is represented by “HBPA-EO_{X}”, wherein x is the sum of m and n (x=m+n). For example, “HBPA-EO₂” means that m+n=2 (m=1 and n=1) in the structure represented by formula (E). “HBPA-EO₃” means that m+n=3 (m=2 and n=1, or m=1 and n=2) in the structure represented by formula (E). On the other hand, the structure shown in formula (F) is represented by “BPA-EOₓ”, wherein x is the sum of m and n (x=m+n). For example, “BPA-EO₂” means that m+n=2 (m=1 and n=1) in the structure represented by formula (F).

In accordance with some embodiments, the dialkyl carbonate that is used in the transesterification reaction may include dimethyl carbonate, diethyl carbonate, dipropyl carbonate, dibutyl carbonate or a combination thereof. In accordance with some embodiments, diethyl carbonate is used in the transesterification reaction.

In accordance with some embodiments, the transesterification reaction of the diols and the dialkyl carbonates is carried out at a temperature of about 120° C. to about 200° C. or of about 130° C. to about 190° C. It should be noted that if the temperature is too low (e.g., lower than 120° C.), the reaction rate of the transesterification may be lowered, resulting in prolonged reaction time; conversely, if the temperature is too high (e.g., higher than 200° C.), significant side effects may occur. In accordance with some embodiments, the reaction time of the transesterification reaction may be in a range from about 5 hours to about 16 hours. In accordance with some embodiments, during the transesterification reaction, the mixture of the by-products (e.g., ethanol) and the unreacted dialkyl carbonates can be removed by distillation. In addition, the degree of polymerization of the polycarbonate prepolymers obtained by the transesterification reaction is in a range from about 2 to about 10 in accordance with some embodiments.

Moreover, in some embodiments, after the transesterification reaction is completed, the steps such as removing the compounds containing hydroxyl groups, removing the unreacted diol monomers, removing the unreacted dialkyl carbonates, and the condensation reaction may be carried out at a temperature of about 120° C. to about 200° C. or of about 130° C. to about 190° C. It should be noted that if the temperature is too low (e.g., lower than 120° C.), the reaction rate of the condensation reaction may be lowered, resulting in a prolonged reaction time; conversely, if the temperature is too high (e.g., higher than 200° C.), decomposition of the polycarbonate prepolymers may occur. In accordance with some embodiments, the reaction time of the condensation reaction may be in a range from about 2 hours to about 15 hours.

In accordance with some embodiments, a catalyst may be used to accelerate the reaction rate of transesterification. In some embodiments, the catalyst may include lithium (Li), sodium (Na), potassium (K), rubidium (Rb), cesium (Cs), magnesium (Mg), calcium (Ca), strontium (Sr), barium (Ba), titanium (Ti), zirconium (Zr), hafnium (Hf), cobalt (Co), zinc (Zn), aluminum (Al), nickel (Ni), tin (Sn), lead (Pb), antimony (antimony), arsenic (As), cerium (Ce), other applicable metallic elements or compounds thereof. The metallic compounds may include oxide, hydroxide, salt, alkoxide or organic compound. In accordance with some embodiments, the catalyst may be titanium butoxide. In accordance with some embodiments, the amount of catalyst used is in range from about 1 ppm to about 10000 ppm or from about 1 ppm to about 1000 ppm, based on the total weight of the raw materials.

A detailed description is given in the following particular embodiments in order to provide a thorough understanding of the present disclosure. However, the scope of the present disclosure is not intended to be limited to the particular embodiments. Furthermore, in the examples and comparative examples, the measurement methods regarding the various properties of the polycarbonate diols or the polyurethane produced by the polycarbonate diols are also explained as follows.

### Example 1: The Preparation of Polycarbonate Diols PC-1

130 g of diethyl carbonate (DEC), 87 g of 1,4-butanediol (referred to as 1,4-BDO), 41 g of 2-[4-(2-hydroxyethoxy)cyclohexyl]-2-[4-(2-hydroxydiethoxy)cyclohexyl]-propane (referred to as HBPA-EO₃) and 20 mg of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were removed by distillation at 180° C. and the condensation reaction was carried out for 4 hours simultaneously. After the reaction was complete, the reaction solution was cooled down to room temperature, and 115 g of the copolymers of polycarbonate diols PC-1, existing in the form of a viscous liquid, was obtained. The obtained copolymers of polycarbonate diols PC-1 had a number average molecular weight of 750, a hydroxyl value of 150 mg KOH/g, and a glass transition temperature (Tg) of −44° C.

### Example 2: The Preparation of Polycarbonate Diols PC-2

117 g of diethyl carbonate (DEC), 82 g of 1,4-butanediol (1,4-BDO), 127 g of 2-[4-(2-hydroxyethoxy)cyclohexyl]-2-[4-(2-hydroxydiethoxy)cyclohexyl]-propane (HBPA-EO₃) and 40 mg of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were removed by distillation at 180° C. and the condensation reaction was carried out for 4 hours simultaneously. After the reaction was complete, the reaction solution was cooled down to room temperature, and 193 g of the copolymers of polycarbonate diols PC-2, existing in the form of a viscous liquid, was obtained. The obtained copolymers of polycarbonate diols PC-2 had a number average molecular weight of 900, a hydroxyl value of 125 mg KOH/g, and a glass transition temperature of −32° C.

### Example 3: The Preparation of Polycarbonate Diols PC-3

80 g of diethyl carbonate (DEC), 43 g of 1,4-butanediol (1,4-BDO), 69 g of 2-bis[4-(2-hydroxyethoxy)cyclohexyl]-propane (referred to as HBPA-EO₂) and 34 mg of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were stirred and removed by distillation at 180° C. and the condensation reaction was carried out for 4 hours simultaneously. After the reaction was complete, the reaction solution was cooled down to room temperature, and 118 g of the copolymers of polycarbonate diols PC-3, existing in the form of a viscous liquid, was obtained. The obtained copolymers of polycarbonate diols PC-2 had a number average molecular weight of 900, a hydroxyl value of 125 mg KOH/g, and a glass transition temperature of −35° C.

### Example 4: The Preparation of Polycarbonate Diols PC-4

80 g of diethyl carbonate (DEC), 58 g of 1,6-hexanediol (referred to as 1,6-HDO), 67 g of 2-bis[4-(2-hydroxyethoxy)cyclohexyl]-propane (HBPA-EO₂) and 36 mg of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were stirred and removed by distillation at 180° C. and the condensation reaction was carried out for 4 hours simultaneously. After the reaction was complete, the reaction solution was cooled down to room temperature, and 135 g of the copolymers of polycarbonate diols PC-4, existing in the form of a viscous liquid, was obtained. The obtained copolymers of polycarbonate diols PC-4 had a number average molecular weight of 800, a hydroxyl value of 140 mg KOH/g, and a glass transition temperature of −30° C.

### Example 5: The Preparation of Polycarbonate Diols PC-5

95 g of diethyl carbonate (DEC), 66 g of 1,4-butanediol (1,4-BDO), 113 g of 2-bis[4-(2-hydroxyethoxy)phenyl]-propane (HBPA-EO₂) and 22 mg of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were removed by distillation at 180° C. and the condensation reaction was carried out for 4 hours simultaneously. After the reaction was complete, the reaction solution was cooled down to room temperature, and 140 g of the copolymers of polycarbonate diols PC-5, existing in the form of a viscous liquid, was obtained. The obtained copolymers of polycarbonate diols PC-5 had a number average molecular weight of 1000, a hydroxyl value of 112 mg KOH/g, and a glass transition temperature of −20° C.

### Comparative Example 1: The Preparation of Polycarbonate Diols PC-6

157 g of diethyl carbonate (DEC), 132 g of 1,4-butanediol (1,4-BDO), and 35 g of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were stirred and removed by distillation at 180° C. and the condensation reaction was carried out for 4 hours simultaneously. After the reaction was complete, the reaction solution was cooled down to room temperature, and 137 g of the copolymers of polycarbonate diols PC-6, existing in the solid form, was obtained. The obtained copolymers of polycarbonate diols PC-6 had a number average molecular weight of 900, and a hydroxyl value of 125 mg KOH/g.

### Comparative Example 2: The Preparation of Polycarbonate Diols PC-7

150 g of diethyl carbonate (DEC), 75 g of 1,6-hexanediol (1,6-HDO), 66 g of 1,5-pentanediol (referred to as 1,5-PDO) and 36 g of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were stirred and removed by distillation at 180° C. and the condensation reaction was carried out for 4 hours simultaneously. After the reaction was complete, the reaction solution was cooled down to room temperature, and 130 g of the copolymers of polycarbonate diols PC-7, existing in the form of a viscous liquid, was obtained. The obtained copolymers of polycarbonate diols PC-7 had a number average molecular weight of 1000, a hydroxyl value of 112 mg KOH/g, and a glass transition temperature of −59.2° C.

### Comparative Example 3: The Preparation of Polycarbonate Diols PC-8

190 g of diethyl carbonate (DEC), 60 g of 1,4-butanediol (1,4-BDO), 60 g of 2-methyl-1,3-propanediol (referred to as MPO), 43 g of polytetramethylene ether glycol (PTMEG), and 15 g of titanium butoxide catalyst were placed into a round-bottom glass flask equipped with a stirrer, a thermometer, and a nitrogen introduction tube. The above materials were stirred in the round-bottom glass flask under normal pressure with nitrogen. The transesterification reaction was carried out for 16 hours while the mixtures of by-products (ethanol) and diethyl carbonates were removed by distillation. During this process, the reaction temperature was slowly raised from 130° C. to 160° C.

Next, the pressure was reduced to 10 torr. The by-products (ethanol), unreacted diethyl carbonates, and unreacted diols were stirred and removed by distillation at 180° C. and the condensation reaction was carried out for 4 hours simultaneously. After the reaction was complete, the reaction solution was cooled down to room temperature, and 113 g of the copolymers of polycarbonate diols PC-8, existing in the form of a viscous liquid, was obtained. The obtained copolymers of polycarbonate diols PC-8 had a number average molecular weight of 1500, a hydroxyl value of 75 mg KOH/g, and a glass transition temperature of −50° C.

The Measurement of OH Value

12.5 g of acetic anhydride was diluted with 50 ml of pyridine to prepare an acetylation reagent. After 2.5 g to 5.0 g of the sample (i.e. the products obtained in the above Examples 1-5 and Comparative Examples 1-3) were weighed and placed into a 100 ml Erlenmeyer flask, 5 ml of the acetylation reagent and 10 ml of toluene were added to the Erlenmeyer flask by a pipette, and a condenser tube was installed. After heating at 100° C. for 1 hour with stirring, 2.5 ml of distilled water was added to the Erlenmeyer flask by a pipette, and then the reaction solution was heated and stirred for 10 minutes. After the reaction solution was cooled down for 2 to 3 minutes, 12.5 ml of ethanol was added, and 2 to 3 drops of phenolphthalein were added to serve as an indicator. Thereafter, the reaction solution was titrated with 0.5 mol/l potassium hydroxide ethanol solution. In addition, 5 ml of acetylation reagent, 10 ml of toluene and 2.5 ml of distilled water were placed in another 100 ml Erlenmeyer flask, and the mixture was heated and stirred for 10 minutes, and then subjected to the same titration (blank test). The hydroxyl value (unit: mg-KOH/g) was calculated using the following formula (I).

Hydroxyl value={(b−a)×28.05×f}/e formula (I)

In formula (I), a represents the titer of sample (ml); b represents the titer of blank test (ml); e represents the weight of sample (g); f represents the titration factor.

The Measurement of Number-Average Molecular Weight (Mn)

The number-average molecular weight can be calculated using the following formula (II).

Number-average molecular weight=2/(hydroxyl value×10⁻³/56.11) formula (II)

The Measurement of Glass Transition Temperature (Tg)

The glass transition temperature can be measured by Differential Scanning Calorimetry (DSC) (instrument model: Q20), and the measurement temperature range is from −100° C. to 100° C.

The results of the properties analysis of the polycarbonate diols prepared in the above Examples 1-5 and Comparative Examples 1-3 are summarized in Table 1.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| polycarbonate | PC-1 | PC-2 | PC-3 | PC-4 | PC-5 | PC-6 | PC-7 | PC-8 |
| diols | | | | | | | | |
| diol monomers | 1,4-BDO | 1,4-BDO | 1,4-BDO | 1,6-HDO | 1,4-BDO | 1,4-BDO | 1,6-HDO | 1,4-BDO |
| | | | | | | | 1,5-PDO | MPO |
| alkylated diol | HBPA-EO₃ | HBPA-EO₃ | HBPA-EO₂ | HBPA-EO₂ | BPA-EO₂ | — | — | PTMEG |
| monomers | | | | | | | | |
| Mn | 750 | 900 | 900 | 800 | 1000 | 900 | 1000 | 1500 |
| hydroxyl value | 150 | 125 | 125 | 140 | 112 | 125 | 112 | 75 |
| (mg-KOH/g) | | | | | | | | |
| Tg (° C.) | −44 | −32 | −35 | −30 | −20 | — | −59.2 | −50 |
| physical state at | liquid | liquid | liquid | liquid | liquid | solid | liquid | liquid |
| room | | | | | | | | |
| temperature | | | | | | | | |

It can be observed from the results in Table 1 that the use of the alkoxylated diol monomers such as HBPA-EO₃ or HBPA-EO₂ in the preparation of the polycarbonate diols can decrease the crystallinity of 1,6-hexanediol or 1,4-butanediol. The polycarbonate diols formed by using HBPA-EO₃ or HBPA-EO₂ are in a liquid state at room temperature. Therefore, such polycarbonate diols are easily operated when they are used for the synthesis of polyurethane.

Next, the polyurethane foam materials are prepared using the polycarbonate diols obtained in Examples 2 and 3 and Comparative Examples 1-3. The foaming ratio (expansion ratio) and the compression strength of the prepared polyurethane foam materials are measured.

### Example 6—the Preparation of Polyurethane Foam Materials PU-1

34 g of the polycarbonate diols (PC-2) obtained in Example 2 were weighed, and 60 g of polyether polyols A and 48 g of polyether polyols B were added thereto and stirred for 30 minutes. Then, 1.8 g of the surfactant, 0.11 g of the catalyst and 4.5 g of water were added and uniformly mixed to form a mixture. Thereafter, 177 g of polymeric methylene diphenyl diisocyanates (PMDI) were added to the mixture and foamed to obtain a thermoplastic polyurethane PU-1.

### Example 7—the Preparation of Polyurethane Foam Materials PU-2

34 g of the polycarbonate diols (PC-3) obtained in Example 3 were weighed, and 60 g of polyether polyols A and 48 g of polyether polyols B were added thereto and stirred for 30 minutes. Then, 1.8 g of the surfactant, 0.11 g of the catalyst and 4.5 g of water were added and uniformly mixed to form a mixture. Thereafter, 177 g of polymeric methylene diphenyl diisocyanates (PMDI) were added to the mixture and foamed to obtain a thermoplastic polyurethane PU-2.

### Comparative Example 4—the Preparation of Polyurethane Foam Materials PU-3

34 g of the polycarbonate diols (PC-6) obtained in Comparative Example 1 were weighed, and 60 g of polyether polyols A and 48 g of polyether polyols B were added thereto and stirred for 30 minutes. Then, 1.8 g of the surfactant, 0.11 g of the catalyst and 4.5 g of water were added and uniformly mixed to form a mixture. Thereafter, 177 g of polymeric methylene diphenyl diisocyanates (PMDI) were added to the mixture and foamed to obtain a thermoplastic polyurethane PU-3.

### Comparative Example 5—the Preparation of Polyurethane Foam Materials PU-4

34 g of the polycarbonate diols (PC-7) obtained in Comparative Example 2 were weighed, and 60 g of polyether polyols A and 48 g of polyether polyols B were added thereto and stirred for 30 minutes. Then, 1.8 g of the surfactant, 0.11 g of the catalyst and 4.5 g of water were added and uniformly mixed to form a mixture. Thereafter, 177 g of polymeric methylene diphenyl diisocyanates (PMDI) were added to the mixture and foamed to obtain a thermoplastic polyurethane PU-4.

### Comparative Example 6—the Preparation of Polyurethane Foam Materials PU-5

34 g of the polycarbonate diols (PC-8) obtained in Comparative Example 3 were weighed, and 60 g of polyether polyols A and 48 g of polyether polyols B were added thereto and stirred for 30 minutes. Then, 1.8 g of the surfactant, 0.11 g of the catalyst and 4.5 g of water were added and uniformly mixed to form a mixture. Thereafter, 177 g of polymeric methylene diphenyl diisocyanates (PMDI) were added to the mixture and foamed to obtain a thermoplastic polyurethane PU-5.

The Measurement of Foaming Ratio

The foaming ratio of the polyurethane foam materials can be determined by a density measurement. Specifically, the density measurement may include the following steps. First, the foaming materials (i.e. the thermoplastic polyurethane obtained in Examples 6-7 and Comparative Examples 4-6) were cut into several test pieces, which have a length of 5 cm, a width of 5 cm, a thickness of 1 cm, and a volume of 25 cm³ (5 cm*5 cm*1 cm=25 cm). Next, the weights (W) of the test pieces were measured using a four-digit analytical balance. The density (D) of the foaming materials may be calculated using the following formula (III) (unit: g/cm³).

D=W/25 formula (III)

The foaming ratio of the foaming material is 1/D (unit: cm³/g).

The Measurement of Compression Strength

First, the foaming materials (i.e. the thermoplastic polyurethane obtained in Examples 6-7 and Comparative Examples 4-6) were cut into several test pieces, which have a length of 5 cm, a width of 5 cm, and an area of 25 cm² (5 cm*5 cm=25 cm²). Next, the test pieces were placed on the platform of an Instron tensile testing machine and an appropriate load cell (e.g., the load cell of 500 kgf) was selected for measurement. When the foaming test pieces were compressed to a height of 0.1 cm, the compression force (F) of the test pieces were recorded. The compression strength (C) of the foaming materials may be calculated using the following formula (IV) (unit: kgf/cm²).

C=F/25 formula (IV)

The results of the properties analysis of the polyurethane foam materials prepared in the above Examples 6-7 and Comparative Examples 4-6 are summarized in Table 2.

TABLE 2

| | | | Comparative | Comparative | Comparative |
|---|---|---|---|---|---|
| | Example 6 | Example 7 | Example 4 | Example 5 | Example 6 |
| polyurethane | PU-1 | PU-2 | PU-3 | PU-4 | PU-5 |
| polycarbonate diols | PC-2 | PC-3 | PC-6 | PC-7 | PC-8 |
| diol monomers | 1,4-BDO | 1,4-BDO | 1,4-BDO | 1,6-HDO | 1,4-BDO |
| | | | | 1,5-PDO | MPO |
| alkoxylated diol | HBPA-EO₃ | HBPA-EO₂ | — | | PTMEG |
| monomers | | | | | |
| compatibility with | good compatibility; | good compatibility; | poor compatibility; | good compatibility; | good compatibility; |
| polyols A and B* | homogeneous at room | homogeneous at | demixing at room | homogeneous at room | homogeneous at room |
| | temperature | temperature | room temperature | temperature | temperature |
| foaming ratio | 17.27 | 19.69 | 17.04 | 18.80 | 18.62 |
| (cm³/g) | | | | | |
| compression strength | 2.54 | 2.13 | 2.19 | 1.69 | 2.06 |
| (kgf/cm²) | | | | | |
| specific strength^{#} | 43.87 | 41.94 | 37.32 | 31.77 | 38.36 |
| (kgf · cm/g) | | | | | |

*Polyols A and B are polyether diols.
^{#}Specific strength = foaming ratio × compression strength.

It can be observed from the results in Table 2 that the polycarbonate diols having alkoxylated cyclic repeating units (Examples 6 and 7) have good compatibility with polyether polyols and maintain good mechanical strength (such as compression strength) when applied to polyurethane foaming materials. Specifically, compared to Comparative Examples 4-6 in which the polycarbonate diols do not have the alkoxylated cyclic repeating unit, the specific strengths of Examples 6 and 7 in which the polycarbonate diols include alkoxylated cyclic repeating units are increased by about 10% to about 40%.

Although some embodiments of the present disclosure and their advantages have been described in detail, it should be understood that various changes, substitutions and alterations can be made herein without departing from the spirit and scope of the disclosure as defined by the appended claims. For example, it will be readily understood by one of ordinary skill in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A polycarbonate diol, comprising
repeating units represented by formula (A) and formula (B); and
hydroxyl groups located at both ends of the polycarbonate diol,
wherein the molar ratio of formula (A) to formula (B) is in a range from 1:99 to 99:1, 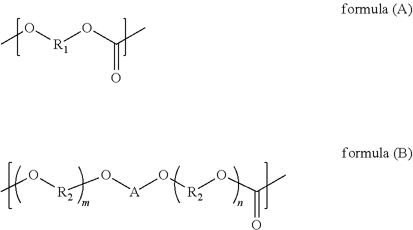
wherein, in formula (A), R₁ is a linear, branched or cyclic C₂₋₂₀ alkylene group; in formula (B), R₂ is a linear or branched C₂₋₁₀ alkylene group; m and n are independently and can be an integer from 0 to 10, and m+n≥1,
wherein A is a C₂₋₂₀ alicyclic hydrocarbon, aromatic ring or a structure represented by formula (C), 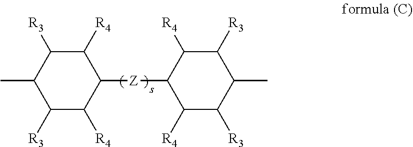
wherein, in formula (C), R₃ and R₄ are independently and can be a hydrogen atom or a C₁₋₆ alkyl group; S is 0 or 1; and Z is selected from 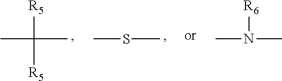
wherein R₅ and R₆ each are independently a hydrogen atom or a C₁₋₁₂ hydrocarbon group.

2. The polycarbonate diol as claimed in claim 1, wherein the number average molecular weight (Mn) of the polycarbonate diol is in a range from 200 to 10000.

3. The polycarbonate diol as claimed in claim 1 wherein the number average molecular weight of the polycarbonate diol is in a range from 500 to 5000.

4. The polycarbonate diol as claimed in claim 1, wherein the molar ratio of formula (A) to formula (B) is in a range from 20:80 to 80:20.

5. The polycarbonate diol as claimed in claim 1, wherein the molar ratio of formula (A) to formula (B) is in a range from 30:70 to 70:30.

6. The polycarbonate diol as claimed in claim 1, wherein R₁ is butylidene or hexylidene in formula (A).

7. The polycarbonate diol as claimed in claim 6, wherein R₁ comprises n-butylidene, t-butylidene, sec-butylidene, isobutylidene, n-hexylidene, t-hexylidene, sec-hexylidene or isohexylidene.

8. The polycarbonate diol as claimed in claim 1, wherein R₂ is a C₂₋₃ alkylene group in formula (B).

9. The polycarbonate diol as claimed in claim 8, wherein R₂ comprises ethylidene or propylidene.

10. The polycarbonate diol as claimed in claim 1, wherein in formula (B), A is

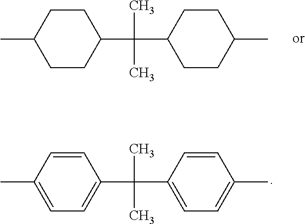

11. The polycarbonate diol as claimed in claim 1, wherein 1≤m+n≤10 in formula (B).

12. The polycarbonate diol as claimed in claim 1, wherein S is 0 in formula (C) and the structure of formula (C) is 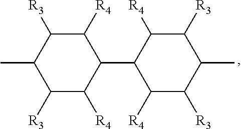
wherein R₃ and R₄ each are independently a hydrogen atom or a C₁₋₆ alkyl group.

13. A method for forming a polycarbonate diol, comprising
performing a transesterification reaction with a first diol monomer, a second diol monomer and a dialkyl carbonate to form a polycarbonate prepolymer; and
performing a condensation reaction with the polycarbonate prepolymer;
wherein the first monomer has a structure represented by HO—R₇—OH,
wherein R₇ is a linear, branched or cyclic C₂₋₂₀ alkylene group,
and the second monomer is an alkoxylated diol.

14. The method for forming a polycarbonate diol as claimed in claim 13, wherein the first monomer comprises ethane-1,2-diol, propane-1,2-diol, propane-1,3-diol, 2,2-dimethyl-1,3-propanediol, 1,4-butanediol, 2-isopropyl-1,4-butanediol, 1,5-pentanediol, 3-methyl-1,5-pentanediol, 2,4-dimethyl-1,5-pentanediol, 2,4-diethyl-1,5-pentanediol, 1,6-hexanediol, 2-ethyl-1,6-hexanediol, 1,7-heptanediol, 1,8-octanediol, 2-methyl-1,8-octanediol, 1,9-nonanediol, 1,10-decanediol, 1,3-cyclohexanediol, 1,4-cyclohexanediol, 1,4-cyclohexanedimethanol, 2-bis(4-hydroxycyclohexyl)-propane) or a combination thereof.

15. The method for forming a polycarbonate diol as claimed in claim 13, wherein the second monomer comprises 2-bis[4-(2-hydroxyethoxy)cyclohexyl]-propane, 2-bis[4-(2-hydroxyethoxy)phenyl]-propane, 2-[4-(2-hydroxyethoxy)cyclohexyl]-2-[4-(2-hydroxydiethoxy)cyclohexyl]-propane, 2-[4-(2-hydroxyethoxy)phenyl]-2-[4-(2-hydroxydiethoxy)phenyl]-propane or a combination thereof.

16. The method for forming a polycarbonate diol as claimed in claim 13, wherein the dialkyl carbonate comprises dimethyl carbonate, diethyl carbonate, dipropyl carbonate, dibutyl carbonate or a combination thereof.

17. The method for forming a polycarbonate diol as claimed in claim 13, wherein the transesterification reaction is carried out at a temperature ranging from 120° C. to 200° C.

18. The method for forming a polycarbonate diol as claimed in claim 13, wherein the condensation reaction is carried out at a temperature ranging from 120° C. to 200° C.

19. The method for forming a polycarbonate diol as claimed in claim 13, wherein a catalyst is used in the transesterification reaction, and the catalyst comprises titanium butoxide.

20. A polyurethane is formed by copolymerization of the polycarbonate diol as claimed in claim 1 and a polyisocyanate.
